(19) United States
(12) Patent Application Publication
(10) Pub. No.: US 2026/0308429 A1
(43) Pub. Date: Oct. 8, 2026

(54) WINDBLADE REPAIR ADHESIVE AND A PROCESS FOR USE THEREOF

(71) Applicant: Illinois Tool Works Inc., Glenview, IL (US)

(72) Inventors: Srihith Bhamidipati, Glenview, IL (US); Adam Visentin, Glenview, IL (US)

(73) Assignee: Illinois Tool Works Inc., Glenview, IL (US)

(21) Appl. No.: 19/639,497

(22) Filed: Apr. 6, 2026

Related U.S. Application Data
(60) Provisional application No. 63/784,398, filed on Apr. 7, 2025.

(51) Int. Cl. C09J 163/04; C09J 11/08; F03D 80/50

(52) U.S. Cl. CPC C09J 163/04; C09J 11/08; F03D 80/502; F05B 2230/80

(57) ABSTRACT

A process of adhesive wind blade repair is provided that includes the application of a pre-mixed two-part adhesive to a wind blade having damage in need of repair. The pre-mixed two-part adhesive is allowed to cure. The adhesive is applied and cured without removing the wind blade from a hub mount to a wind turbine. The cure occurs to a glass transition temperature of 65° C. in between 5 and 360 minutes and at an ambient temperature of between −10° C. and +40° C. The adhesive composition includes two parts thar are stored separately and cure upon intermixing. The first part includes epoxy resin functionality. A second part containing amine curing agents includes an aliphatic polyamine, a cycloaliphatic amine, and a tertiary amine.

### RELATED APPLICATIONS

This application is a non-provisional application that claims priority benefit of U.S. Provisional Application Ser. No. 63/784,398, filed 7 Apr. 2025; the contents of which are hereby incorporated by reference.

### FIELD OF THE INVENTION

The present invention in general relates to coatings and in particular to a wind blade repair compositions that cure at ambient temperatures thereby facilitating in situ repairs.

### BACKGROUND OF THE INVENTION

Wind turbines are used to generate electricity from the kinetic power of the wind. Large blades at the front of the turbine assembly have a special curved shape, similar to the airfoil wings on a plane. When wind blows past a turbine's blades, the wind spins the blades around, and the rotational movement of the blades drives a generator that converts the kinetic energy to electrical power.

Wind turbine blades are generally made of composite materials. However, the surfaces of composite materials (for example composite materials made of glass fiber fabric or nonwoven and epoxy resin/vinyl ester resin) typically have a poor appearance and are not resistant to ultra violet light (UV) and weathering. However, over time, ultraviolet radiation from the sun, weather, pollution, and other environmental factors can wear away the exterior surface of the wind blades of a turbine. This wear reduces operation efficiency and if not addressed can cause blade delamination induced failure.

Conventional products used to repair turbine blades are 2 part formulations, often epoxies, that have cure rates are ambient temperature that are impractical and instead are cured at elevated temperatures. By way of example, peak glass transition temperatures in excess of 80° C. are only achieved after 4 hours cure at 70° C. Maintaining such large structures in a repair jig for numerous days or more to exact a repair at ambient temperature is simply not viable. As a result, when such repairs are required, turbine blades must be dismounted and placed in an oven to completed such repairs and limit building stress into the repaired blade.

Thus, there exists a need for a wind turbine blade repair composition that cures quicker than conventional adhesives at ambient temperature. There further exists a need for a method to repair a turbine blade without disassembly of the turbine hub, and dismounting the blade from the turbine tower to drastically reduce repair effort.

### SUMMARY OF THE INVENTION

A process of adhesive wind blade repair is provided that includes the application of a pre-mixed two-part adhesive to a wind blade having damage in need of repair. The pre-mixed two-part adhesive is allowed to cure. The adhesive includes an epoxy novolac resin, or a diglycidyl ether of bisphenol F; and several types of amine curing agents effective to cure the resin, The adhesive is applied and cured without removing the wind blade from a hub mount to a wind turbine. The cure occurs to a glass transition temperature of 65° C. in between 5 and 360 minutes and at an ambient temperature of between −10° C. and +40° C.

The adhesive composition includes two parts thar are stored separately and cure upon intermixing. The first part includes an epoxy phenol novolac resin, a modified epoxy-terminated elastomer adduct of diglycidyl ether of neopentyl glycol, and carboxyl terminated butadiene acrylonitrile. A second part containing amine curing agents includes an aliphatic polyamine, a cycloaliphatic amine, and a tertiary amine.

### DETAILED DESCRIPTION OF THE INVENTION

The present invention has utility as an ambient temperature curing, injectable, non-sagging two-part epoxy adhesive composition used to fill voids and otherwise repair a wind blade. The epoxy has a high initial onset glass transition temperature of 65° C., with full cure onset being >70° C. This initial onset cure occurs in a time from 5 to 360 minutes. In contrast to the prior art, invention cures quickly enough at ambient temperature to minimize the use of additional heat (e.g. heat blankets or infrared lamps) that current wind blade adhesives require. The need to dismount a wind blade from the hub of a wind turbine for such repairs is also precluded. An inventive process results that is more efficient than that with conventional adhesives that cure too slowly at ambient temperature to allow for in place wind blade repair. Exemplary damage to a wind blade repaired includes a crack, impact damage, or leading edge erosion.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

The terminology used herein is for the purpose of describing particular example embodiments only and is not intended to be limiting. Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. Unless indicated otherwise, explicitly or by context, the following terms are used herein as set forth below.

As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

While the present invention is largely detailed with respect to wind blade repairs, it is appreciated that the present invention also finds application in the context it also has applications in the fields of aerospace, automotive repair, architectural structures, and industrial equipment repair. In aerospace, the invention is used during an initial assembly or a repair of an aerospace vehicle. The aerospace vehicle illustratively includes aircraft, spacecraft, missiles, bombs, rockets, drones, and components of any of the aforementioned. Such components illustratively include a frame, a skin, a flight control surface, a foil, a cowling, a blade, a fin, a wing, a tail, a landing gear, a fuselage, an aileron, a winglet, an elevator, a stabilizer, a rudder, a flap, an air brake, a slat, a spoiler, an aircraft canopy, a turbine, a door, a fuel tank, or a subassembly thereof. A subassembly illustratively includes an aileron, an air inlet, a boarding ladder, a bomb door, a bracket, a bulkhead, a control surface, a crew floor, a door, an elevator, an empennage, an engine cowl, an engine mount, an entry door, a fairing, a fin, a flap, a floor beam, a floor, a foil, a fuel cell, a fuel floor, a fuel tank, a fuselage, a gun door, a hinge, an instrument panel, a landing gear, a latch, a longeron, a nose, a nosecone, a pylon, a rib, a rudder, a skin, a spar, a spoiler, a stabilizer, a stringer, a tail, a thermal protector, a wheel well, a wing box, a wing, a winglet, or others.

The present invention also finds application in the context of architectural structures and used during an initial assembly or a repair of a building. The building illustratively includes a dwelling, a warehouse, a basement, a water or fuel tank, or a skyscraper

An innovative feature that distinguishes current invention from prior art is the ability to cure to high initial onset glass transition temperature (Tg) of 65° C., with full cure onset being Tg >70° C. This initial onset cure occurs in a time for 5 and 360 minutes; a shorter cure time compared to conventional products. The inventive composition also has desirable properties relative to the prior art in that the add mixed combination of the two parts has a sufficiently low viscosity to be injected with only the application of manual pressure.

As used herein, the glass transition temperature is defined as the temperature at which an inventive adhesive polymer moves from a glassy state to a flexible state, as measured by Differential Scanning calorimetry (DSC) at a rate of ramp rate of 10° C./minute.

While the present invention is detailed herein with respect to a 1:1 by volume ratio mixture of part one:part two, it is appreciated that other mix ratios are readily compounded ranging from 1:1±10% to 10:1±10% to 1:10±10% part one:part two without departing from the spirit of the present invention.

An inventive composition achieves faster cure through a combination of amine curing agents for the functionalities of the part one composition. Part one of an inventive formulation includes an epoxy phenol novolac resin, a modified epoxy-terminated elastomer adduct of diglycidyl ether of neopentyl glycol. The epoxy phenol novolac resin operative herein have an epoxy content of from 2 to 10 equivalents/mole. Exemplary phenolic epoxy resins operative herein have an epoxide equivalent weight of from 100 to 1000 grams/equivalent. The epoxy phenol novolac resin typically has an average functionality of 2.1 to 2.9. In some inventive embodiments, the epoxy phenol novolac resin is modified to include carboxy terminated butadiene-acrylonitrile to enhance adhesive strength and flexibility. This is synonymous denoted herein as Part 1A.

In other inventive embodiments, Part one of an inventive formulation includes diglycidyl ether of bisphenol F. The diglycidyl ether of bisphenol F operative herein have typically ranges between 155 and 180 g/eq and a viscosity of 25° C. of between 500-10,000 cP. In some inventive embodiments, the diglycidyl ether of bisphenol F is the only curable resin present while in other inventive embodiments, diglycidyl ether of bisphenol F is copolymerized with a bisphenol A diglycidyl ether. A typical weight ratio of diglycidyl ether of bisphenol F:bisphenol A diglycidyl ether, if bisphenol A diglycidyl ether is present is between 3:8:1. This Part one is synonymous denoted herein as Part 1B.

While other components can be present in Part 1A, an epoxy phenol novolac resin, a modified epoxy-terminated elastomer adduct of diglycidyl ether of neopentyl glycol are present in combination from 55 to 100 weight percent of part one. The novolac phenolic resin is typically present in part one from 52.5 to 95.5 total weight percent. In still other embodiments, the weight ratio of the (epoxy phenol novolac resin):(modified epoxy-terminated elastomer adduct of diglycidyl ether of neopentyl glycol) is from 6-22:1.

The Mn of novolac phenolic resin operative in the present invention is between 250 and 1200. Novolac phenolic resins are supplied as liquids or in solvents aqueous or alcoholic with resulting viscosities from 50 to 50,000 cps, or as solids in the form of lumps, granules, or fine powders. In some inventive embodiments, the novolac phenolic resin is present as a powder dispersed in a liquid or solution resol phenolic resin.

While other components can be present in Part 1B, diglycidyl ether of bisphenol F alone, or in combination with bisphenol A diglycidyl ether are present in combination from 60 to 100 weight percent of Part 1B. The diglycidyl ether of bisphenol F is typically present in part 1B from 70 to 90 total weight percent and bisphenol A diglycidyl ether is present from 10 to 20 total weight percent.

In some inventive embodiments, shell of poly(methyl methacrylate) (PMMA) with a butadiene rubber core nanoparticles (200 to 450 nm diameter) are provided to increase impact strength. The detail of such core-shell nanoparticles are known to the art. J. H. Backet al., Polymers 2019, 11, 152. Such core-shell nanoparticles are present from 0 to 30 weight percent of part one.

The present invention achieves ambient temperature cure of Part 1A or Part 1B based adhesive, a property not considered possible by the conventions of the field. The resins Part 1A or Part 1B conventionally require the presence of a curing agent to complete cure, and as a result the industry commonly refers to these resins as two-stage products. The most common phenolic resin curing agent is hexamethylenetetramine that is used as powder dispersed throughout the resin that is activated by heating. A bonding network of aromatic phenolics accounts for the hardness and the heat resistant properties for the resulting articles. Regardless of whether the curing agent is provided premixed with the resin or added as a separate component, convention dictates that heat is required to initiate cure. The present invention achieves timely ambient temperature cure through a synergistic combination of amine curatives.

In some inventive embodiments, the modified epoxy-terminated elastomer adduct of diglycidyl ether of neopentyl glycol includes butadiene acrylonitrile blocks in the backbone thereof. Without intending to be bound to a particular theory, the inclusion of butadiene acrylonitrile functionality is believed to impart flexibility, impact resistance, and function as an adhesion promoter to an inventive adhesive.

A Part 1A or Part 1B of an inventive adhesive formulation in certain embodiments also includes various additive such as chelating agents, corrosion inhibitors, thickeners, pigments, thixotropic agents, plasticizers, viscosity regulators, and combinations thereof. Such additives are limited only by the requirement of compatibility with the other components of an inventive formulation. Such additives are provided to balance or otherwise modify at least one property of an inventive formulation as to handling, storage, cure rate, or adhesive properties. Typical loading of each additive in an inventive formulation is independently from 0 to 5 total weight percent of in a 1:1, 4:1, or 10:1 adhesive:activator formulation or 0 to 10 weight percent of part one prior to mixing with part two.

A Part 1A or Part 1B of an inventive adhesive formulation may also include a filler. A filler operative herein illustratively includes fumed silica; carbon black; alumina, such as tabular alumina; titania; calcium carbonate, hollow microspheres of either glass or plastics, or combinations thereof. Such fillers serve to not only reduce cost but blunt crack propagation through a cured matrix of an inventive adhesive thereby improving the strength thereof. Fillers are each independently present from 0 to 35 weight percent of part one and no more than 43 weight percent of part one in total.

Typical component amounts for an inventive adhesive are provided in Table 1.

TABLE 1
Typical component amounts for adhesive (Part 1A or Part 1B) of a 1:1
volumetric ratio with part one, where amounts are given in weight
percentages unless otherwise noted:
Part One Composition:

| Component (A or B): | Amount: | |
|---|---|---|
| A. Novolac phenolic resin | 52.5-95 | (62.60-73.9) |
| A. Modified epoxy-terminated | Weight ratio of 1:6-22 relative to novolac | |
| elastomer adduct of | phenolic resin | |
| diglycidyl ether of | | |
| neopentyl glycol | | |
| B. Diglycidyl ether of | Up to 100% | |
| bisphenol F | | |
| B. Bisphenol A diglycidyl | 0-30 | |
| ether | | |
| Fillers: | 0-40 total | |
| e.g. Fumed Silica | 0-35 | (2.10-3.7) |
| e.g. Alumina | 0-35 | (22.25-8.0) |
| e.g. Hollow spheres | 0-35 | (2.45-0.4) |

| | |
|---|---|
| Core-shell nanoparticles | 0-30 |
| Optional additives each | 0-remainder |
| up to 5% | |

The ability to achieve an adhesive that achieves a glass transition temperature of 65° C. in between 5 and 360 minutes and at an ambient temperature of between −10° C. and +40° C. is based on a combination of the amine curing agents that include aliphatic polyamines, cycloaliphatic amine, and tertiary amines. While it is appreciated that the present invention part one and part two can vary in volume ratio from one another, the amounts of amine curing agents are selected to assure cure of all the epoxy functionality present in part one.

Aliphatic polyamine amine curing agent is present in part two of an inventive adhesive composition. Aliphatic polyamine amine curing agents operative herein include an aliphatic polyamine Mannich base with an amine equivalent weight of 60-90 (75) g/eq, such as ANCAMINE 2719®, a polyamine inclusive of reaction products of p-toluenesulfonic acid in ionic liquid, such as ANCAMINE 2914UF®, aliphatic amine product of m-xylylenediamine with an active hydrogen equivalent of 40-80 (49) and a viscosity of 100-5000 (2000) centipoise, such as ANCAMINE 2422®, or a combination thereof. Typical loadings of aliphatic polyamine amine curing agents are from 20 to 50 total weight percent of part two. In certain inventive embodiments at least two, and in some instances, at least three of the aforementioned aliphatic polyamine amine curing agents are present in part two. In those embodiments of the present invention inclusive of several aliphatic polyamine amine curing agents, each one is present from 1 to 49 total weight percent of part two.

Cycloaliphatic amine curing agent is present in part two of an inventive adhesive composition. Cycloaliphatic amine curing agents operative herein include isophorone diamine, 4,4′-diaminodicyclohexylmethane, 3,3′-dimethyl-4,4′-diaminodicyclohexylmethane, cyclohexylamine, ANCAMINE 2659®, and combinations thereof. Typical loadings of cycloaliphatic amine curing agents are from 10 to 50 total weight percent of part two. In certain inventive embodiments at least two, and in some instances, at least three of the aforementioned cycloaliphatic amine curing agents are present in part two. In those embodiments of the present invention inclusive of several cycloaliphatic amine curing agents, each one is present from 3 to 47 total weight percent of Part two.

Tertiary amine curing agent is present in Part two of an inventive adhesive composition. Tertiary amine curing agents operative herein include 1,3-bis[3-(dimethylamino)propyl]urea, N,N-dimethylbenzylamine, N,N-dimethylethanolamine, N-methylmorpholine, triethylamine and combinations thereof. Typical loadings of tertiary amine curing agents are from 0.1 to 10 total weight percent of Part two. In certain inventive embodiments at least two, and in some instances, at least three of the aforementioned tertiatry amine curing agents are present in Part two. In those embodiments of the present invention inclusive of several aliphatic polyamine amine curing agents, each one is present from 0.1 to 9.9 total weight percent of Part two.

A Part two of an inventive adhesive formulation in certain embodiments also includes various additive such as chelating agents, corrosion inhibitors, thickeners, pigments, thixotropic agents, plasticizers, viscosity regulators, and combinations thereof. Such additives are limited only by the requirement of compatibility with the other components of an inventive formulation. Such additives are provided to balance or otherwise modify at least one property of an inventive formulation as to handling, storage, cure rate, or adhesive properties. Typical loading of each additive in an inventive formulation is independently from 0 to 5 total weight percent of in a 1:1, 4:1, or 10:1 adhesive:activator formulation or 0 to 10 weight percent of Part one prior to mixing with Part two. It is appreciated that a pigment in one or both of Part one or Part two affords a visual indicator of complete mixing of the two parts. Prototypical of such pigments are white and black to yield gray upon thorough mixing, or white and red to yield pink upon thorough mixing.

A Part two of an inventive adhesive formulation may also include a filler. A filler operative herein illustratively includes fumed silica; carbon black; alumina, such as tabular alumina; titania; calcium carbonate, hollow microspheres of either glass or plastics, or combinations thereof. Such fillers serve to not only reduce cost but blunt crack propagation through a cured matrix of an inventive adhesive thereby improving the strength thereof. Fillers are each independently present from 0 to 45 weight percent of Part two and no more than 50 weight percent of Part two in total.

Typical component amounts for an inventive adhesive curative (Part two) are provided in Table 2.

TABLE 2
Typical component amounts for adhesive (Part Two) of a 1:1
volumetric ratio with Part 1A or Part 1B , where amounts are
given in weight percentages unless otherwise noted:
Part Two Composition:

| | Typical | Preferred |
|---|---|---|
| Component: | Amount: | Amount: |
| Aliphatic polyamine curing | 20-50 | 22-48 |
| agent(s) | | |
| e.g. aliphatic polyamine | 1-20 | 8-18 |
| Mannich base with an | | |
| amine equivalent weight | | |
| of 60-90 | | |
| e.g. polyamine inclusive of | 1-20 | 5-18 |
| reaction products of | | |
| p-toluenesulfonic acid in ionic | | |
| liquid | | |
| e.g. aliphatic amine product | 1-20 | 3-13 |
| of m-xylylenediamine with an | | |
| active hydrogen equivalent of | | |
| 40-80 | | |
| Cycloaliphatic amine curing | 10-50 | 9-43 |
| agent(s) | | |
| Tertiary amines curing | 0-10 | 0.6-2 |
| agent(s) | | |
| Fillers: | 0-50 in total | |
| e.g. Fumed Silica | 0-45 | 2-8 |
| e.g. Calcium carbonate | 0-45 | 13-42 |
| e.g. Hollow spheres | 0-45 | 0.5-6 |
| Optional additives each up | 0-remainder | 0-remainder |
| to 5% | | |

A process is provided for producing an adhesive formulation produced by combination of the two parts to bonds well to wind turbine blade composite substrates. An inventive adhesive formulation is a two-part formulation that is either premixed to initiate a time period pot life, or alternatively the two parts are co-applied to a substrate under conditions for polymerization to occur between the various monomers. In specific inventive embodiments, polymerization occurs at between-10 and 40° C. in ambient atmosphere. In other embodiments, cure is initiated without resort to energy inputs such as heating or ultraviolet radiation exposure and without detaching the wind turbine blade from the turbine hub. In certain inventive embodiments in which the adhesive Part 1A or Part 1B, and activator Part two are present in a 1:1, 4:1, or 10:1 volumetric ratio=10%, storage stability of more than 180 days at 23° C. is obtained. Typical viscosities of Parts one and two are each independently between 100 and 2,000 cPs to promote injection. It is appreciated that a dual-barrel injector is well-suited for simultaneous mixing and application of an inventive adhesive formulation. In some inventive embodiments the separate Parts one and two have viscosities that are within +50 percent of one another to facilitate mixing therebetween.

Regardless of the form of an inventive adhesive formulation, upon induction of pot life for the formulation, the formulation is present in simultaneous contact with two or more substrates with the substrates held in contact with the curing inventive formulation for an amount of time sufficient to achieve a bond between the substrates. An inventive formulation is well-suited for bonding vinyl polymers, fiberglass resins, sheet molding compositions, and ______. Two such substrates can be brought together to form various adjoined structures such as a lap joint, butt joint, corner joint, edge joint, and T-joint. In still other embodiments, an inventive adhesive formulation is applied to a single substrate and allowed to cure to form a coating that offers substrate protection or is operative as a primer for subsequent material applications. An inventive adhesive formulation can be applied to a variety of thicknesses and still achieve polymerization throughout. Typical thicknesses of an inventive formulation between substrates range from 0.001-25 mm. In some inventive embodiments, the adhesive Parts one and two mixture is degassed prior to cure.

An inventive adhesive in some embodiments rapidly builds strength achieve a glass transition temperature of 65° C. in between 5 and 360 minutes and at an ambient temperature of between −10° C. and +40° C.

Specific exemplary formulations of an inventive composition are provided, unless noted otherwise, all percentages for the specific formulation are total weight percentages. The advantages of this invention are more particularly shown by the following example in which the parts and percentages are by weight unless otherwise indicated.

### EXAMPLES

### Example 1

A specific embodiment of the inventive adhesive formulation is provided that includes as Part one: epoxy phenol novolac resin with an average functionality of 2.65 in an amount of 61 weight percent with a modified epoxy-terminated elastomer adduct of diglycidyl ether of neopentyl glycol that contains 50% elastomer by weight in an amount of 11 weight percent, fumed silica is present in an amount of 2 weight percent, hollow glass spheres having a mean diameter of 60 microns are present in an amount of 2 weight with the remainder being tabular alumina filler.

Part two includes 1,3-bis[3-(dimethylamino)propyl]urea present in an amount of 1 weight percent, isophorone diamine present in an amount of 15 weight percent, an aliphatic polyamine Mannich base with an amine equivalent weight of 75 g/eq present in an amount of 15 weight percent, a polyamine inclusive of reaction products of p-toluenesulfonic acid in ionic liquid present in an amount of 12 weight percent, an aliphatic amine product of m-xylylenediamine with an active hydrogen equivalent of 49 and a viscosity of 2000 centipoise, iron oxide (red) present in an amount of 3 weight percent, hollow glass spheres having a mean diameter of 60 microns are present in an amount of 2 weight with the remainder being 4 micron calcium carbonate. Part one and Part two are combined in a 11 volumetric ratio.

### Example 2

The adhesive formulation of Example 1 is repeated without the inclusion of a polyamine inclusive of reaction products of p-toluenesulfonic acid in ionic liquid in Part two, with the amounts of isophorone diamine and the aliphatic polyamine Mannich base each increased to 21 weight percent with like properties to those of Example 1.

### Example 3

The adhesive formulation of Example 1 is repeated with the epoxy phenol novolac resin present in an amount of 77 weight percent with a commensurate reduction in the amount of filler. Like properties to those of Example 1 results.

### Example 4

The adhesive formulation of Example 1 is repeated with the replacement of 1,3-bis[3-(dimethylamino)propyl]urea with a like amount of N,N-dimethylethanolamine. Like properties to those of Example 1 results.

### Example 5

The adhesive formulation of Example 1 is repeated with the isophorone diamine amount present increased to 48 weight percent with a commensurate reduction in the amount of the filler. Like properties to those of Example 1 results.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

1. A process of adhesive wind blade repair comprising:
applying a pre-mixed two-part adhesive to a wind blade having damage in need of repair; and
allowing the pre-mixed two-part adhesive to cure;
wherein the pre-mixed two part adhesive comprises an epoxy novolac resin, diglycidyl ether of bisphenol F, or a combination thereof; a core-shell rubber; and a plurality of amine curing agents effective to cure the epoxy novolac resin, the diglycidyl ether of bisphenol F, or the combination thereof;
with the proviso that the wind blade remains mounted to a hub of a wind turbine and cure occurs at a glass transition onset temperature of 60° C. to 65° C. in between 5 and 360 minutes and at an ambient temperature of between 10° C. and 50° C.

2. The process of claim 1 wherein the damage is a crack, impact damage, or leading edge erosion.

3. The process of claim 1 further comprising degassing the pre-mixed two part adhesive.

4. The process of claim 1 wherein the applying is injecting.

5. The process of claim 4 wherein the injecting is from a two-barrel syringe with a mixing tip.

6. The process of claim 1 wherein the pre-mixed two part adhesive has a viscosity of between 300,000-1,000,000 cP at the moment of the applying as measured by ASTM D5225.

7. The process of claim 1 wherein the plurality of amine curing agents comprises at least one aliphatic polyamine, at least one cycloaliphatic amine, and at least one tertiary amine.

8. The process of claim 1 wherein the occurs without resort to a heating blanket or an infrared heater with the proviso that the adhesive has a thickness of greater than 8 mm.

9. The process of claim 1 wherein the cure has a terminal glass transition temperature of between 70° C. and 90° C.

10. The process of claim 1 wherein the cured adhesive has a tack free time of 120 minutes.

11. The process of claim 1 wherein upon cure the adhesive has a lap shear strength of greater between 10 and 25 MPa per ASTM D1002.

12. The process of claim 1 wherein upon cure the adhesive has a gel time of approximately 40 minutes per ASTM D3056.

13. An adhesive composition comprising:
a first part comprising:
(A) epoxy phenol novolac resin,
a modified epoxy-terminated elastomer adduct of diglycidyl ether of neopentyl glycol, and
carboxyl terminated butadiene acrylonitrile; or
(B) diglycidyl ether of bisphenol F and a core-shell rubber; and
a second part containing amine curing agents comprising:
an aliphatic polyamine,
a cycloaliphatic amine, and
a tertiary amine.

14. The composition of claim 13 further comprising core-shell nanoparticles in the first part.

15. The composition of claim 13 further comprising a filler in the first part, the second part, or a combination thereof.

16. The composition of claim 13 further comprising a silane adhesion agent in the first part, the second part, or a combination thereof.

17. The composition of claim 13 further comprising an inorganic pigment in one of the first part or the second part to indicate by a pre-selected terminal color to an unaided, normal human eye that the first part and the second part are homogeneously mixed.

18. The composition of claim 13 wherein the tertiary amine comprises 1,3-bis[3-(dimethylamino)propyl]urea.

19. The composition of claim 13 wherein the aliphatic polyamine comprises a Mannich base.

20. The composition of claim 13 wherein the aliphatic polyamine further comprises p-toluenesulfonic acid reaction product functionality or a product of xylylenediamine.
